(19) United States
(12) Patent Application Publication
(10) Pub. No.: US 2004/0155956 A1
(43) Pub. Date: Aug. 12, 2004

(54) System for maintaining eye contract during videoconferencing

(76) Inventor: Kent Alexander Libbey, Palo Alto, CA (US)

Correspondence Address: Kent A. Libbey, 737 Oregon Avenue, Palo Alto, CA, 94303, US

(21) Appl. No.: 10/771,024

(22) Filed: Feb. 3, 2004

Related U.S. Application Data
(60) Provisional application No. 60/444,907, filed on Feb. 3, 2003.

(51) Int. Cl. H04N 7/14

(52) U.S. Cl. 348/14.16; 348/14.01

(57) ABSTRACT

This invention is a system for maintaining eye contact during videoconferencing. Unlike prior art, it involves no special materials or software and can work with common and pre-existing person computer cameras and monitors. If this system is used by participants on both sides of the videoconference, the result is a natural conversation between the participants, with eye contact as if they are sitting across from each other. Unlike prior art, which are full-screen, dedicated systems, the present invention accommodates common ‘windows’ based applications.

### CROSS REFERENCE TO RELATED APPLICATION

This application is entitled to the benefit of Provisional Patent Application Ser. No. 60/444,907 filed Feb. 3, 2004.

### FIELD OF INVENTION

This invention relates to the field of videoconferencing, and more specifically to systems used to establish and maintain eye contact between participants in a videoconference.

### BACKGROUND

Video conferencing technology is rapidly entering the mainstream of communications, with the convergence of low-cost, powerful PCs, inexpensive PC cameras and broadband data communications in homes and businesses. By 2010 people capable of video conferencing will number in the tens, if not hundreds, of millions. However, with all of the advances in technology and communication networks, a common problem with video conferencing persists-maintaining eye contact with the other party(ies) on the conference. This is because in virtually all currently available commercial video conferencing systems (whether targeting consumers or large businesses) the camera on the local participant(s) and the image of the remote participant(s) are separated. That is, participants cannot simultaneously look at the camera and at the image of the remote participants. The result is a disconcerting lack of mutual eye contact, a behavior that is would never be accepted in normal interpersonal dealings on a face-to-face basis.

Researchers have long recognized this problem, and several patents have been granted to address the problem, but the solutions to date have been both complex and costly, resulting in a lack of commercialization. Furthermore, most of the research seems to have been focused on dedicated, professional video conferencing systems, which comprise only a small fraction of the existing and prospective market for this mode of communication. In fact, the most videoconferencing occurs (and will occur for the foreseeable future) on personal computers (PCs). And, of course, PCs come in many different shapes and sizes-including workstations with large CRT monitors, desktop systems with CRT or LCD systems and a variety of laptop and notebook configurations. Likewise, PC cameras come in a wide assortment, with millions already in use. Like most PC applications, especially video-oriented applications, video conferencing images are usually contained in a ‘window’, which takes up a fraction of the monitor screen.

U.S. Pat. No. 5,117,285 to Nelson and Smoot (1992) is indicative of the systems that have been developed to address eye contact during videoconferencing. The system involves complex apparatus built around the whole monitor with specially designed polarized glass. This might be acceptable for dedicated, professional videoconferencing systems, but would not be feasible for personal computers, which are general purpose in nature (and which video conferencing is only one of many applications—and only occasionally used at that).

U.S. Pat. No. 5,317,405 to Kuriki et al. (1994) also addresses the issue of eye contact during videoconferencing. This system involves the use of specially arranged, half-silvered glass strips, arranged in a saw-tooth configuration that simultaneously allows a local user to look through the strips to see the remote user, while reflecting the image of the local user to a camera mounted above or below the screen. Like prior art, this system requires software to (on either the sending or receiving side) to reverse the mirror image of the local participant. In addition, like prior art, the camera protrudes out from the monitor, which requires not only special apparatus and attachments, but also additional space to accommodate. Likewise, U.S. Pat. No. 5,639,151 to McNelley et al. (1997) is oriented to a dedicated desktop or kiosk video conferencing system. This invention requires an elaborate set of parts, including moving parts, and a specially design camera system. As in previous inventions, this patent employs partially silvered glass to superimpose the image of the remote participant over the local camera's field of capture.

U.S. Pat. No. 5,666,153 to Copeland in 1997 attempted to address some of these issues by developing a folding apparatus for maintaining eye contact during videoconferencing that retrofits to a standard cathode ray terminal (CRT) monitor. However, this system is still very cumbersome. It is designed to be dedicated to a single CRT—and is not portable from one monitor to another. It may be necessary to design different systems for different sizes of CRT (e.g., 15 inch versus 17 or 19 inch monitors). It certainly is not designed for laptop monitors or LCD monitors, which are becoming increasingly pervasive, especially in businesses and broadband-enabled homes, where personal videoconferencing is most likely to occur.

There have also been references in other patents to prior art that involves the user looking through a partially silvered pane of glass to an image on a monitor, while his image is reflected by way of a mirror to a camera. This approach is problematic because the camera must protrude from the front of the monitor and the entire system must be secured to the monitor.

Other published research (e.g., by Hewlett Packard in 2002), involves extremely complex computer software, in which two- and three-dimensional models of users' faces to create the illusion that participants in a videoconference are looking into the camera, even though in actuality they are looking at an image on the screen.

In conclusion, all of the existing patents and prior art for maintaining eye contact during videoconferencing that are known to the inventor have one or more of the following challenges: dedicated apparatus; excess space; specially built cameras or materials; special software; incompatibility with thin, laptop and LCD monitors; and lack of portability. Consequently, none has been a commercial success.

### SUMMARY

The present invention—a simple, low-cost personal computer (PC) accessory—is designed to solve the challenge of maintaining eye contact during videoconferencing and resolve the challenges of prior art and inventions. Like prior art, the invention employs partially silvered glass to place the image of the remote participant in the camera's ‘line of sight.’ However, unlike prior art, it involves no special materials or software and works with the installed base of over 10 million PC cameras and over 100 million PC monitors.

The system employs two pieces of reflective material (e.g., glass or plastic), one that is fully reflective (i.e., a mirror) and the other that is partially reflective (i.e., a ‘one-way’ mirror). The planes of said materials are positioned in the configuration of a periscope—parallel to each and at a 45-degree angle to the viewer and object being viewed (in this case an image on a monitor)—with the one-way mirror on top. A camera is positioned behind the one-way mirror on top, allowing a user of the system to simultaneously view image of the other participant(s) in the videoconference while also looking directly into the camera. Alternatively, the one-way mirror can be positioned in front of the image of the remote participant(s) on the monitor while reflecting the image of the local participant(s) to a mirror above, which then conveys said image to the camera positioned behind it.

If this system is used on both sides of the videoconference, the result is a natural conversation between the participants, as if they are sitting across from each other.

This invention can be manufactured and sold inexpensively and can be designed to fold into a compact space that easily fits into a normal briefcase. Its simple design can be reconfigured easily to accommodate full-screen applications, which may be more appropriate to group video conferencing scenarios, as well as partial screen, personal video conferencing applications. The latter case is common because the available bandwidth between video conferencing parties limits the image resolution to less than a quarter of the size of a typical monitor. Furthermore, in the case of PC-based videoconferencing software, the imaged displayed is typically only one of several applications or ‘windows’ on the screen. Unlike all prior art known to the inventor, which are full-screen systems, the present invention accommodates common ‘windows’ based applications; further reducing the size and cost of the product.

Not only does this invention work with PC monitors and cameras in use today, it also solves a common problem experienced of using a PC camera with a thin monitor: where to put the camera. Most PC cameras in use today have flat base, designed to sit on top of a large cathode ray terminal (CRT), common to most desktop PC systems. However, a growing number of desktop systems, and virtually all notebook PCs, use relatively thin and lightweight liquid crystal display (LCD) technology for the monitor, which does not provide a flat base to place an existing PC camera. Several manufacturers offer specially designed PC cameras for LCD screens (e.g., cameras built of clamp on to thin screens instead of sit on a flat base). However, this solution is not portable between en LCD and CRT monitors, and specifically doesn't address a common situation of laptop users ‘docking’ into CRT display system when operated at a home base.

The present invention is highly portable and can be installed in a matter of seconds. In fact, the inventor's prototypes work effectively without an attachments—permanent or temporary—to the PC monitor, relying simply on the upside-L shaped design which rests on a monitor screen that is tilted slightly away from the user. The user simply places the system on the monitor, which can be either a CRT or LCD, and uses the computer cursor to position to the image of the remote user on the monitor so that it is seen through the system. Quick and easy installation, removal and replacement of the system is important because the user may want to move the displayed image from one part of the screen to another, or quickly remove and replace it, in order to see other running applications.

### DRAWINGS

FIG. 1 shows the typical configuration of PC-based videoconferencing systems and the resulting image transmitted, with eyes deflected by the physical separation of the transmitting camera and the received image.

FIG. 2 shows the configuration of a PC-based videoconference system using the present invention.

FIG. 3 shows the present invention as seen by the user, based on a partial screen design.

FIG. 4 shows a cross-section of the invention itself, indicating the positioning of the two pieces of reflective material, along with the platform for a pre-existing PC camera.

FIG. 5 shows and alternative configuration of the invention with the local viewer's image being captured through reflection off the partially reflective surface to a fully reflective surface above and positioned in front of the camera.

### DESCRIPTION

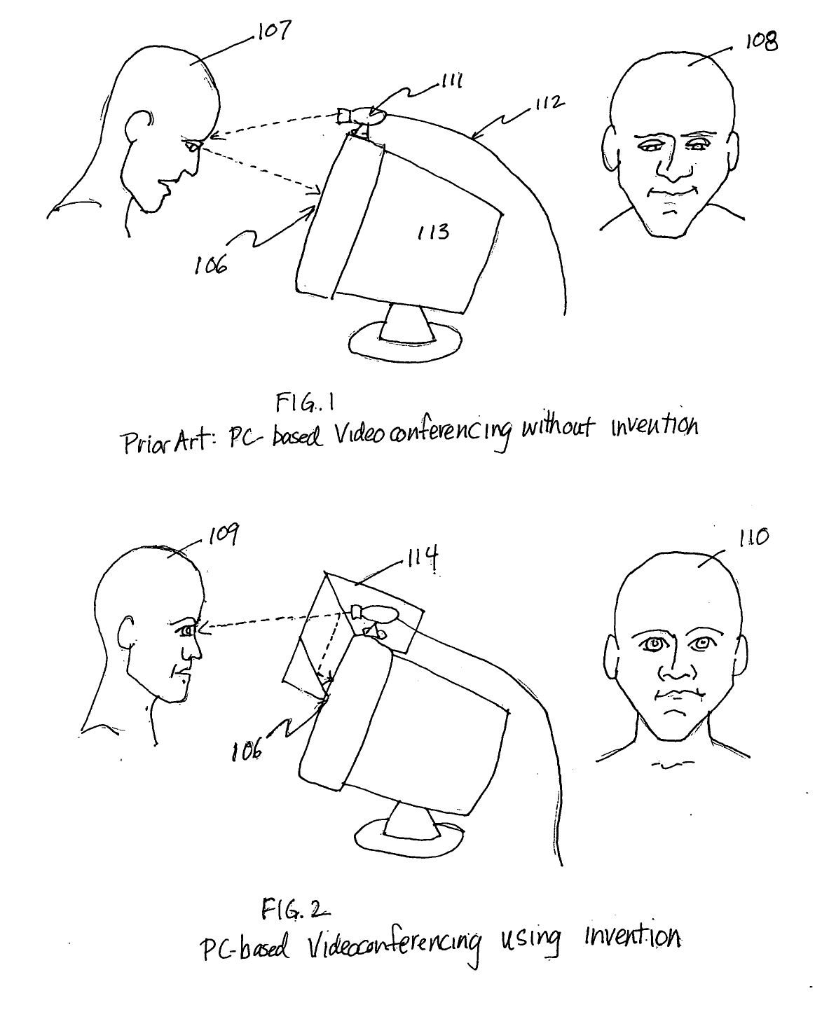

FIG. 1 shows the typical configuration of PC-based videoconferencing systems today. The local participant 107 looks at the image 106 on the monitor 113, while the camera 111 captures his image and sends this image via a cord 112 to the PC, which then transmits it to the remote participant via a telecommunications network. Because the image 6 and the camera 111 are physically separated, the remote participant sees the local participant looking away 108.

FIG. 2 shows a cross-section of the present invention 114, used with a pre-existing CRT monitor 113 and PC camera 111. The camera 111 is housed inside the invention 114 and ‘looks’ through the partially silvered glass 116. Meanwhile the local participant 109 looks directly at the partially reflective material 116, which reflects the image on the screen 106 via the parallel mirror 115 positioned below it and in front of the monitor 113. Because the image being viewed 106 is now in the camera's direct line of sight, the image transmitted to the remote participant 110 appears to be looking directly into the camera. If both participants are using the invention, then the result is natural eye contact, as if they are in the same room.

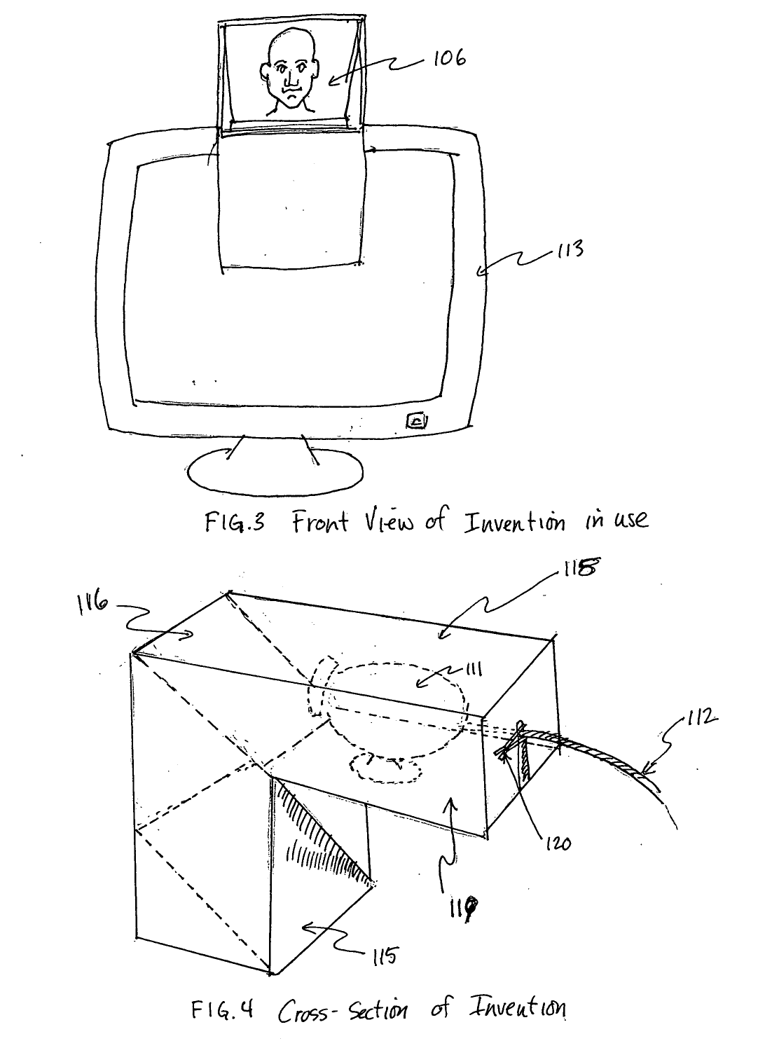

FIG. 3 shows the invention as viewed from the perspective of the local participant. From the viewer's perspective the image on the screen 106 now appears as a reflection on the half-silvered glass positioned above the monitor. Because of the canopy 115 covering the camera from ambient light, the viewer does not see the camera behind the glass. However, the camera can ‘see through’ the one-way mirror and capture the image of the local participant.

FIG. 4 shows a cross-section of the invention itself, indicating the positioning of the two pieces of glass, along with the platform for a pre-existing PC camera. By positioning the mirror 115 and one-way mirror 116 in parallel, the two mirrors effectively cancel each other out, thus negating any special software on either the sending or the receiving side of the videoconference to reverse a mirror image, which is required in several instances of prior art. The camera rests on a built-in platform 119. The camera cord 112 goes through a slot in the back of the canopy 118 and can secured in position with a clip 120 to ensure the camera does not move around within the invention.

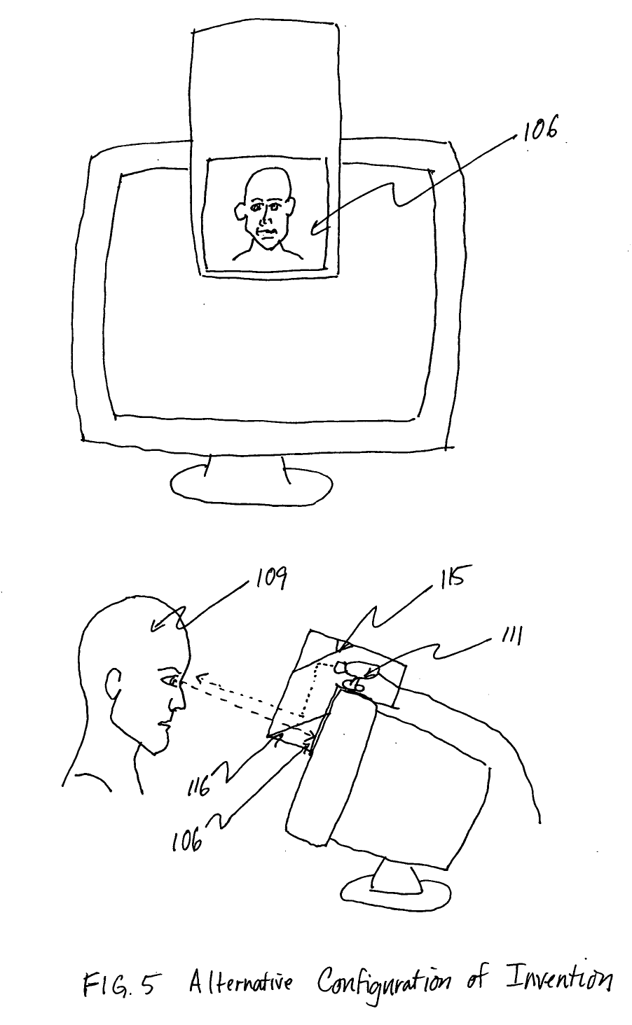

FIG. 5 shows an alternative configuration of the invention in which the partially reflective material is placed in front the monitor screen where the remote participant's image is displayed 106 and the fully reflective material is placed directly above it and in front of the camera 111. In this configuration the local participant 109 looks through the partially reflective material at the image on the monitor while the camera 111 captures his image through the fully reflective material 115 of reflecting off the partially reflective material 116.

### REFERENCE NUMERALS

106 image of remote participant(s) on PC monitor screen

107 local participant(s) without invention

108 image of local participant transmitted to remote participant without invention

109 local participant(s) with invention

110 image of local participant transmitted to remote participant with invention

111 existing PC camera

112 existing PC camera cord

113 PC monitor

114 cross-section of invention

115 fully reflective material

116 partially reflective material

118 canopy over camera

119 camera platform

120 clip to secure camera cord existing PC monitor

### OPERATIONS

In operation, the local participant 109 simply opens the canopy 118, places his existing PC camera 111 on the platform 119, behind the partially reflective material 116 and secures the cord with the clip 120. Then he rests the entire invention on the PC monitor 113 and uses his PC mouse to position the image of the remote participant 106 to where it can be seen clearly through the partially reflective material 116. In general, there should be not need to physically secure the system to the monitor; it simply balances by the natural distribution of weight between the two panes of glass toward the front and the camera cantilevered toward the back. In doing so:

(1) The local participant 109 is looking at image of the remote participant 106, while simultaneously looking, head-up, directly into the camera 111, thus maintaining continuous eye contact throughout the videoconference session.

(2) There is a convenient place to put and keep the PC camera, even in the case of a laptop or other LCD screen, which does not offer a natural platform.

(3) The entire system can be moved to another part of the screen or removed altogether in seconds for the local participant to view other windows or applications running on his PC.

(

4) No special software or assembly or apparatus is required.

(5) The system can be moved from one PC to another, even if the PCs are of different form factors (e.g., desktop with CRT monitor and notebook with LCD monitor).

### Additional Embodiments

In addition to the embodiment described above, which involves a fixed enclosure of the two glass panes and the camera platform, this invention could be embodied with any or all of the following attributes:

(1) A folding configuration, allowing the entire system (excluding pre existing camera and monitor) to be collapsed in order to fit within a desk drawer or briefcase.

(2) An integrated camera for those users without a pre-existing camera or for manufacturers that want to differentiate their product(s).

(3) A full-screen version, which might be preferred for group video conferencing.

### CONCLUSIONS, RAMIFICATIONS AND ADVANTAGES

This system addresses the awkward experience of existing video conferencing systems-including inexpensive systems for personal computers and expensive.

Ramifications:

The system could fundamentally improve the experience of video conferencing, substantially increasing the use of this technology. This system can be applied to personal computers (desktops and notebooks) with any size, shape or type (CRT or LCD) screen or to professional systems that use large-screen televisions. The system can be design to retrofit all existing monitors and video conferencing cameras, including inexpensive personal PC cameras and expensive profession cameras. The system can be also easily and inexpensively be integrated with cameras and/or monitors with the distinctive feature of maintaining eye contact. In addition to video conferencing, this system can also be used an inexpensive means of teleprompting (i.e., reading prepared text while looking directly into the camera).

Advantages:

Simplicity and flexibility are outstanding features of this system:

(1) It is simple (and inexpensive) to build: No electronics or moving parts are necessary to achieve the purpose of this system (though they may be integrated into the system at the option of manufacturers). There is no special software required for the system to work effectively.

(2) It is simple to use: The system can be used without any special installation or technical knowledge. It can be set up or removed in a matter of seconds.

(3) The system can be retrofitted with the existing installed base of personal computer systems (over 100 million), existing PC video cameras (tens of millions), and professional systems (tens of thousands).

(4) It can be used in full-screen systems (e.g., dedicated room video conferencing systems) or can be designed in a much smaller form factor to work with partial screen video conferencing software that is in common use today.

1. A system for capturing and displaying images of participants in a videoconference comprising: means for placing the image of the remote participant in the line of sight between the local participant and the local camera capturing the image of said local participant, whereby eye contact is established and maintained during the videoconference, comprising:
a. common and pre-existing personal computer monitors, including cathode ray tubes and liquid crystal displays of desktop and laptop and notebook computers, and
b. common and pre-existing personal computer video cameras, including cameras with a flat base, and
c. partial- or full-screen images of remote participants, and
d. common and pre-existing videoconferencing software, and
e. common and pre-existing communications network connections.

2. An apparatus of claim 1 comprising the elements of:
a. a rigid construction of two pieces of reflective material, one that is fully reflective and the other that is partially reflective, wherein
b. the planes of said reflective materials are positioned parallel to each other, and at a 45-degree angles toward the local participant and away from the image of the remote participant on the monitor, and
c. a camera positioned behind the partially reflective material on top, whereby the local participant looks through said material at the lens of the camera, and
d. the partially reflective material in front the camera reflects the image of the remote participant off the monitor by way of a fully reflective, whereby
e. the local user of the system simultaneously views the image of the remote participant in the videoconference while also looking directly into the camera.

3. An apparatus of claim 1 comprising the elements of:
a. a folding construction of two pieces of reflective material, one that is fully reflective and the other that is partially reflective, wherein
b. the planes of said reflective materials are positioned parallel to each other, and at a 45-degree angles toward the local participant and away from the image of the remote participant on the monitor, and
c. a camera positioned behind the partially reflective material on top, whereby the local participant looks through said material at the lens of the camera, and
d. the partially reflective material in front the camera reflects the image of the remote participant off the monitor by way of a fully reflective, whereby
e. the local user of the system simultaneously views the image of the remote participant in the videoconference while also looking directly into the camera.

4. An apparatus of claim 1 comprising the elements of:
a. a rigid construction of two pieces of reflective material, one that is fully reflective and the other that is partially reflective, wherein
b. the planes of said reflective materials are positioned parallel to each other, and at a 45-degree angles away from the local participant and toward the image of the remote participant on the monitor, and
c. the partially reflective material is placed directly in front of the image of the remote participant on the monitor screen and wherein the local participant looks through said material at the image of the remote participant, and
d. the image of the local participant is partially reflected by said material to the fully reflective material positioned directly above it which is positioned directly in front of the video camera lens whereby
e. the local user of the system simultaneously views the image of the remote participant in the videoconference while also looking directly into the camera.

5. An apparatus of claim 1 comprising the elements of:
a. a folding construction of two pieces of reflective material, one that is fully reflective and the other that is partially reflective, wherein
b. the planes of said reflective materials are positioned parallel to each other, and at a 45-degree angles away from the local participant and toward the image of the remote participant on the monitor, and
c. the partially reflective material is placed directly in front of the image of the remote participant on the monitor screen and wherein the local participant looks through said material at the image of the remote participant, and
d. the image of the local participant is partially reflected by said material to the fully reflective material positioned directly above it which is positioned directly in front of the video camera lens whereby
e. the local user of the system simultaneously views the image of the remote participant in the videoconference while also looking directly into the camera.

6. A system for capturing and displaying images of participants in a videoconference comprising: means for placing the image of the remote participant in the line of sight between the local participant and the local camera capturing the image of said local participant, whereby eye contact is established and maintained during the videoconference, comprising:
a. common and pre-existing personal computer monitors, including cathode ray tubes and liquid crystal displays of desktop and laptop and notebook computers, and
b. specially built or integrated personal computer video cameras, and
c. partial- or full-screen images of remote participants, and
d. common and pre-existing videoconferencing software, and
e. common and pre-existing communications network connections.

7. An apparatus of claim 6 comprising the elements of:
a. a rigid construction of two pieces of reflective material, one that is fully reflective and the other that is partially reflective, wherein
b. the planes of said reflective materials are positioned parallel to each other, and at a 45-degree angles toward the local participant and away from the image of the remote participant on the monitor, and
c. a camera positioned behind the partially reflective material on top, whereby the local participant looks through said material at the lens of the camera, and
d. the partially reflective material in front the camera reflects the image of the remote participant off the monitor by way of a fully reflective, whereby
e. the local user of the system simultaneously views the image of the remote participant in the videoconference while also looking directly into the camera.

8. An apparatus of claim 6 comprising the elements of:
a. a folding construction of two pieces of reflective material, one that is fully reflective and the other that is partially reflective, wherein
b. the planes of said reflective materials are positioned parallel to each other, and at a 45-degree angles toward the local participant and away from the image of the remote participant on the monitor, and
c. a camera positioned behind the partially reflective material on top, whereby the local participant looks through said material at the lens of the camera, and
d. the partially reflective material in front the camera reflects the image of the remote participant off the monitor by way of a fully reflective, whereby
e. the local user of the system simultaneously views the image of the remote participant in the videoconference while also looking directly into the camera.

9. An apparatus of claim 6 comprising the elements of:
a. a rigid construction of two pieces of reflective material, one that is fully reflective and the other that is partially reflective, wherein
b. the planes of said reflective materials are positioned parallel to each other, and at a 45-degree angles away from the local participant and toward the image of the remote participant on the monitor, and
c. the partially reflective material is placed directly in front of the image of the remote participant on the monitor screen and wherein the local participant looks through said material at the image of the remote participant, and
d. the image of the local participant is partially reflected by said material to the fully reflective material positioned directly above it which is positioned directly in front of the video camera lens, whereby
e. the local user of the system simultaneously views the image of the remote participant in the videoconference while also looking directly into the camera.

10. An apparatus of claim 6 comprising the elements of:
a. a folding construction of two pieces of reflective material, one that is fully reflective and the other that is partially reflective, wherein
b. the planes of said reflective materials are positioned parallel to each other, and at a 45-degree angles away from the local participant and toward the image of the remote participant on the monitor, and
c. the partially reflective material is placed directly in front of the image of the remote participant on the monitor screen and wherein the local participant looks through said material at the image of the remote participant, and
d. the image of the local participant is partially reflected by said material to the fully reflective material positioned directly above it which is positioned directly in front of the video camera lens, whereby
e. the local user of the system simultaneously views the image of the remote participant in the videoconference while also looking directly into the camera.
